(19) United States
(12) Patent Application Publication
(10) Pub. No.: US 2007/0211815 A1
(43) Pub. Date: Sep. 13, 2007

(54) METHOD AND APPARATUS FOR SCALING SOFT BITS FOR DECODING

(75) Inventors: Jung-Lin Pan, Smithtown, NY (US); Donald M. Grieco, Manhassett, NY (US); Nirav Shah, Huntington Station, NY (US); Robert Lind Olesen, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/683,806

(22) Filed: Mar. 8, 2007

Related U.S. Application Data
(60) Provisional application No. 60/781,132, filed on Mar. 10, 2006.
(60) Provisional application No. 60/889,632, filed on Feb. 13, 2007.

(51) Int. Cl. H04L 1/02

(52) U.S. Cl. 375/267

(57) ABSTRACT

A method and apparatus for scaling a soft bit for decoding in a wireless communication system are described. A scaling factor is calculated for a received symbol based on an estimated signal-to-noise ratio (SNR) of the received symbol and the scaling factor is applied to a soft bit of the received symbol. A multiple-input multiple-output (MIMO) scheme may be implemented to transmit multiple data streams. In such case, a soft bit of a received symbol on each data stream is scaled by a scaling factor for the received symbol on each data stream.

### CROSS REFERENCE TO RELATED APPLICATIONS

This application claims the benefit of U.S. Provisional Application Nos. 60/781,132 filed Mar. 10, 2006 and 60/889,632 filed Feb. 13, 2007, which are incorporated by reference as if fully set forth.

### FIELD OF INVENTION

The present invention is related to wireless communication systems. More particularly, the present invention is related to a method and apparatus for scaling a soft bit for decoding. The present invention is applicable to any wireless communication systems including, but not limited to, a single carrier frequency division multiple access (SC-FDMA) system.

### BACKGROUND

Developers of third generation (3G) wireless communication systems are considering long term evolution (LTE) of the 3G systems to develop a new radio access network for providing a high-data-rate, low-latency, packet-optimized, improved system with higher capacity and better coverage. In order to achieve these goals, instead of using code division multiple access (CDMA), which is currently used in the 3G systems, SC-FDMA is proposed as an air interface for performing uplink transmission in LTE.

The basic uplink transmission scheme in LTE is based on a low peak-to-average power ratio (PAPR) SC-FDMA transmission with a cyclic prefix (CP) to achieve uplink inter-user orthogonality and to enable efficient frequency-domain equalization at the receiver side. Both localized and distributed transmission may be used to support both frequency-adaptive and frequency-diversity transmission.

FIG. 1 shows a conventional sub-frame structure for uplink transmission as proposed in LTE. The sub-frame includes six long blocks (LBs) 1-6 and two short blocks (SBs) 1 and 2. The SBs 1 and 2 are used for reference signals, (i.e., pilots), for coherent demodulation and/or control or data transmission. The LBs 1-6 are used for control and/or data transmission. A minimum uplink transmission time interval (TTI) is equal to the duration of the sub-frame. It is possible to concatenate multiple sub-frames or timeslots into longer uplink TTI.

Multiple-input multiple-output (MIMO) refers to a wireless transmission and reception scheme where both a transmitter and a receiver employ more than one antenna. A MIMO system takes advantage of the spatial diversity or spatial multiplexing (SM) to improve the signal-to-noise ratio (SNR) and increases throughput. MIMO has many benefits including improved spectrum efficiency, improved bit rate and robustness at the cell edge, reduced inter-cell and intra-cell interference, improvement in system capacity and reduced average transmit power requirements.

In a decoding process, a scaling is required after soft demapping. Without appropriate scaling, the decoder, (e.g., Turbo decoder), will suffer significant performance degradation or even performance breakdown.

Therefore, it would be desirable to provide a method and apparatus for correct scaling of a soft bit for decoding.

### SUMMARY

The present invention is related to a method and apparatus for scaling a soft bit for decoding a wireless communication system. A scaling factor is calculated for a received symbol based on an estimated SNR of the received symbol and the scaling factor is applied to a soft bit of the received symbol. A MIMO scheme may be implemented to transmit multiple data streams. In such case, a soft bit of a received symbol on each data stream is scaled by a scaling factor for the received symbol on each data stream.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a conventional sub-frame format proposed for SC-FDMA in LTE;

FIG. 2 is an exemplary block diagram of a WTRU configured in accordance with the present invention;

FIG. 3 shows transmit and receive processing steps in accordance with the present invention; and

FIG. 4 is an exemplary block diagram of a Node-B configured in accordance with the present invention.

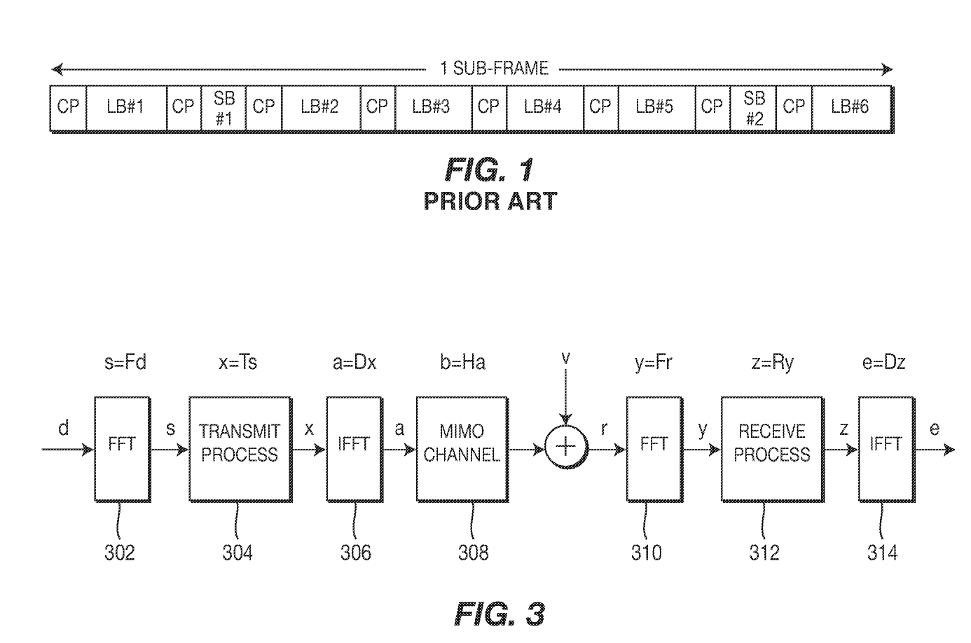

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, a cellular telephone, a personal data assistance (PDA), a computer, or any other type of user device capable of operating in a wireless environment. When referred to hereafter, the terminology “Node-B” includes but is not limited to a base station, a site controller, an access point (AP) or any other type of interfacing device in a wireless environment.

The present invention provides a method and apparatus for scaling a soft bit in an SC-FDMA system that use a fast Fourier transform (FFT) or a discrete Fourier transform (DFT) spreading across multiple subcarriers. The present invention may be applied to the SC-FDMA system with or without a MIMO scheme.

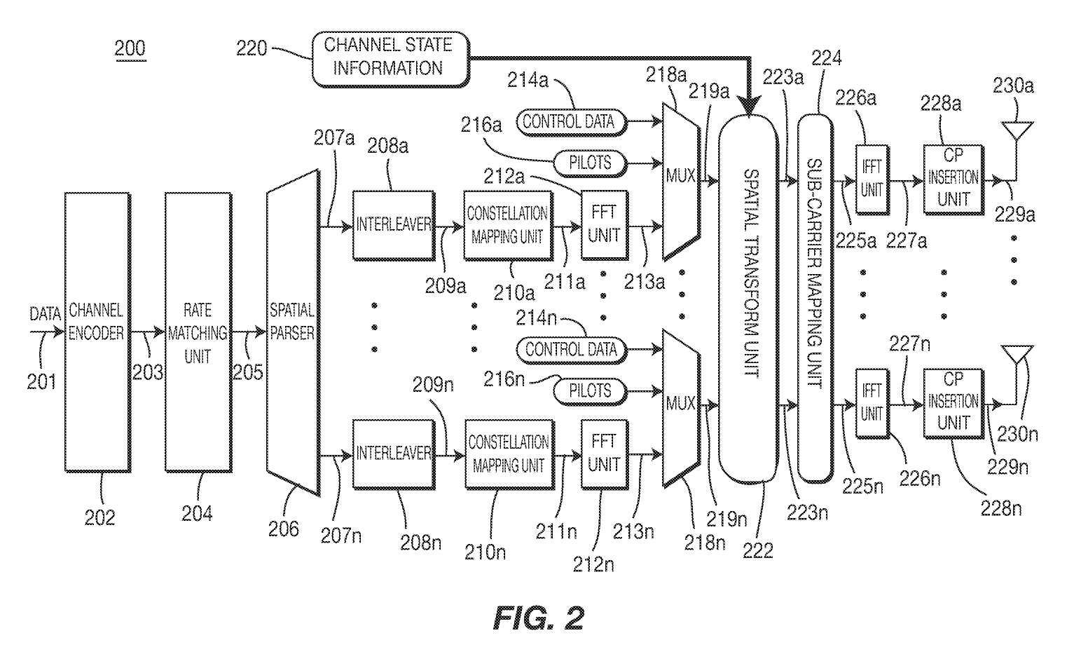

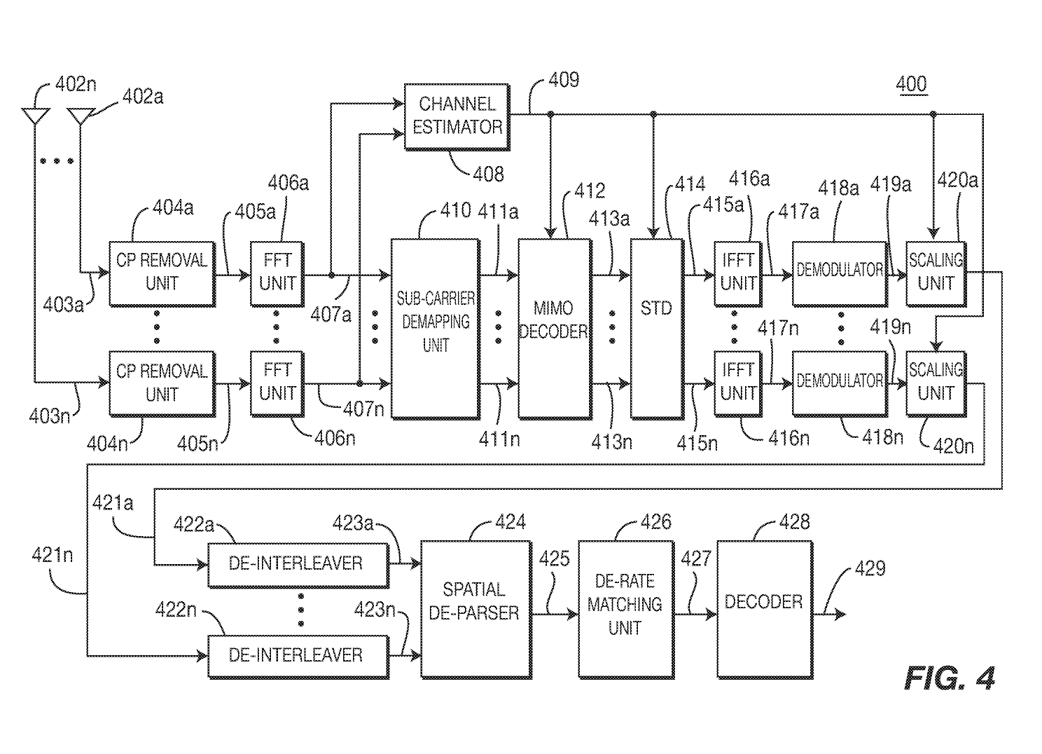

FIGS. 2 and 4 are exemplary block diagrams of a WTRU 200 and a Node-B 400 configured in accordance with the present invention. The WTRU 200 and the Node-B 400 selectively implement space time coding (STC), SM, or transmit beamforming for uplink transmission in a MIMO SC-FDMA system. For STC, any form of STC may be used including space time block coding (STBC), space frequency block coding (SFBC), quasi-orthogonal Alamouti for four (4) transmit antennas, time reversed STBC (TR-STBC), cyclic delay diversity (CDD), phase shift delay diversity (PDD), or the like. Hereinafter, the present invention will be explained with reference to STBC and SFBC as representative examples for STC schemes. SFBC has a higher resilience to channels that have high time selectivity and low frequency selectivity, while STBC may be used if the time selectivity is low. Because the advantages of STC versus transmit beamforming are dependent on channel conditions, (e.g., SNR), the mode of transmission, (e.g., STC vs. transmit beamforming), is selected based on a suitable channel metric.

Referring to FIG. 2, the WTRU 200 includes a channel encoder 202, a rate matching unit 204, a spatial parser 206, a plurality of interleavers 208a-208n, a plurality of constellation mapping units 210a-201n, a plurality of fast Fourier transform (FFT) units 212a-212n, a plurality of multiplexers 218a-218n, a spatial transform unit 222, a subcarrier mapping unit 224, a plurality of inverse fast Fourier transform (IFFT) units 226a-226n, a plurality of CP insertion units 228a-228n and a plurality of antennas 230a-230n. It should be noted that the configuration of the WTRU 200 in FIG. 2 is provided as an example, not as a limitation, and the processing may be performed by more or less components and the order of processing may be changed.

The channel encoder 202 encodes input data 201. Adaptive modulation and coding (AMC) is used where any coding rate and any coding scheme may be used. For example, the coding rate may be 1/2, 1/3, 1/5, 3/4, 5/6, 8/9 or the like. Alternatively, no coding may be performed. The coding scheme may be Turbo coding, convolutional coding, block coding, low density parity check (LDPC) coding, or the like. The encoded data 203 may be punctured by the rate matching unit 204. Alternatively, multiple input data streams may be encoded and punctured by multiple channel encoders and rate matching units.

The encoded data after rate matching 205 is parsed into a plurality of data streams 207a-207n by the spatial parser 206. Data bits on each data stream 207a-207n are preferably interleaved by the interleavers 208a-208n. The data bits after interleaving 209a-209n are then mapped to symbols 211a-211n by the constellation mapping units 210a-210n in accordance with a selected modulation scheme. The modulation scheme may be binary phase shift keying (BPSK), Quadrature phase shift keying (QPSK), 8 phase shift keying (8PSK), 16 Quadrature amplitude modulation (QAM), 64 QAM, or similar modulation schemes. Symbols 211a-211n on each data stream is processed by the FFT unit 212a-212n which outputs frequency domain data 213a-213n. Control data 214a-214n and/or pilots 216a-216n are multiplexed with the frequency domain data 213a-213n by the multiplexer 218a-218n. The frequency domain data 219a-219n (including the multiplexed control data 214a-214n and/or pilots 216a-216n) is processed by the spatial transform unit 222.

The spatial transform unit 222 selectively performs one of transmit beamforming, pre-coding, STC, SM, or any combination thereof on the frequency domain data 213a-213n based on channel state information 220. The channel state information 220 may contain channel impulse response or pre-coding matrix and may also contain at least one of an SNR, a WTRU speed, a channel matrix rank, a channel condition number, delay spread, and short term and/or long term channel statistics. The condition number is related to the rank of the channel. An ill-conditioned channel may be rank deficient. A low rank or ill-conditioned channel would exhibit better robustness using a diversity scheme, such as STBC, since the channel would not have a sufficient degree of freedom to support SM with transmit beamforming. A high rank channel would support higher data rates using SM with transmit beamforming. At low WTRU speed, close-loop pre-coding or transmit beamforming may be selected while at high WTRU speed, open-loop SM or transmit diversity scheme, (such as STC), may be chosen. When an SNR is high, close-loop transmit beamforming may be selected while at a low SNR, transmit diversity scheme may be preferred. The channel state information 220 may be obtained from a Node-B using conventional techniques, such as direct channel feedback (DCFB).

The transmit beamforming may be performed using a channel matrix decomposition method, (e.g., singular value decomposition (SVD)), a codebook and index-based precoding method, an SM method, or the like. For example, in pre-coding or transmit beamforming using SVD, a channel matrix is estimated and decomposed using SVD and the resulting right singular vectors or the quantized right singular vectors are used for the pre-coding matrix or beamforming vectors. In pre-coding or transmit beamforming using codebook and index-based method, a pre-coding matrix in a codebook that has the highest SNR is selected and the index to this pre-coding matrix is fed back. Metrics other than SNR may be used as selection criterion such as mean square error (MSE), channel capacity, bit error rate (BER), block error rate (BLER), throughput, or the like, In SM, the identity matrix is used as a pre-coding matrix, (i.e., there is actually no pre-coding weight applied to antennas for SM). SM is supported by the transmit beamforming architecture transparently (simply no-feedback of precoding matrix or beamforming vectors needed). The transmit beamforming scheme approaches the Shannon bound at a high SNR for a low complexity MMSE detector. Because of transmit processing at the WTRU 200, the transmit beamforming minimizes the required transmit power at the expense of a small additional feedback.

The symbol streams 223a-223n processed by the spatial transform unit 222 are then mapped to subcarriers by the subcarrier mapping unit 224. The subcarrier mapping may be either distributed subcarrier mapping or localized subcarrier mapping. The subcarrier mapped data 225a-225n is then processed by the IFFT units 226a-226n which output time domain data 227a-227n. A CP is added to the time domain data 227a-227n by the CP insertion unit 228a-228n. The time domain data with CP 229a-229n is then transmitted via antennas 230a-230n.

The WTRU 200 supports both a single stream with a single codeword, (e.g., for SFBC), and one or more streams or codewords with transmit beamforming. Codewords can be seen as data streams that are independently channel-coded with independent cyclic redundancy check (CRC). Different codewords may use the same time-frequency-code resource.

FIG. 3 shows transmit and receive processing steps in a transmitter and a receiver in accordance with the present invention. At the transmitter, an FFT spreading is performed on transmit symbols d to generate a signal s, (s=Fd) (step 302). F represents an FFT operation. After the FFT spreading, a transmit processing is performed on the signal s to generate a signal x, (x=Ts) (step 304). T represents transmit processing. An IFFT processing is then performed on the signal x to generate a signal a, (a=Dx) (step 306). D represents an IFFT operation. The signal a is then transmitted via a MIMO channel (step 308).

At the receiver, an FFT processing is performed on a received signal r, (y=Fr) (step 310). A receive processing is then performed on the signal y, (z=Ry) (step 312). R represents receive processing. An IFFT processing is then performed on the signal z to generate estimated transmitted data symbols e, (e=Dz) (step 314). The size of FFT and IFFT both at the transmitter and the receiver may be different from each other in order to support multi-user multiple access for SC-FDMA MIMO systems.

For transmit beamforming, a channel matrix is decomposed using a singular value decomposition (SVD) or equivalent method as follows:
H=UDV^{H}. Equation (1)

The spatial transform for SM or transmit beamforming may be expressed as follows:
x=Ts; Equation (2)
where the matrix T is a generalized transform matrix. In the case that transmit eigen-beamforming is used, the transform matrix T is chosen to be a beamforming matrix V which is obtained from the SVD operation above, (i.e., T=V). Transmit beamforming-based MIMO for SC-FDMA maximizes the throughput and minimizes interference.

In addition to multiplexing schemes and eigen-beamforming, other lower complexity methods may perform better in some circumstances. Among these methods are diversity schemes, such as SFBC or STBC. In general, the encoded data for SFBC or STBC may be expressed as follows:

$$[ \begin{matrix}{d}_{2 n} & {d}_{2 n + 1} \\ - {d}_{2 n + 1}^{*} & {d}_{2 n}^{*}\end{matrix} ] ;$$

where the first and second row of the above matrix represents the encoded data for antennas 1 and 2, respectively, after SFBC or STBC encoding using Alamouti scheme. When SFBC is used, d₂ₙ and d₂ₙ₊₁ represent the data symbols of the subcarriers 2n and 2n+1 for a pair of subcarriers. When STBC is used, d₂ₙ and d₂ₙ₊₁ represent two adjacent OFDM symbols 2n and 2n+1. Both schemes have the same effective code rate.

Referring to FIG. 4, the Node-B 400 comprises a plurality of antennas 402a-402n, a plurality of CP removal units 404a-404n, a plurality of FFT units 406a-406n, a channel estimator 408, a subcarrier de-mapping unit 410, a MIMO decoder 412, a spatial time decoder (STD) 414, a plurality of IFFT units 416a-416n, a plurality of demodulators 418a-418n, a plurality of scaling units 420a-420n, a plurality of de-interleavers 422a-422n, a spatial de-parser 424, a de-rate matching unit 426, and a decoder 428. It should be noted that the configuration of the Node-B 400 in FIG. 4 is provided as an example, not as a limitation, and the processing may be performed by more or less components and the order of processing may be changed. For example, instead of one output data stream, multiple output data streams may be generated and each of the output data streams may be separately decoded by multiple decoders.

The CP removal units 404a-404n remove a CP from each of the received data streams 403a-403n from each of the receive antennas 402a-402n. The received data streams after CP removal 405a-405n are converted to frequency domain data 407a-407n by the FFT units 406a-406n. The channel estimator 408 generates a channel estimate 409 from the frequency domain data 407a-407n using conventional methods. The channel estimation is performed on a per sub-carrier basis. The subcarrier de-mapping unit 410 performs the opposite operation which is performed at the WTRU 200 of FIG. 2. The subcarrier de-mapped data 411a-411n is then processed by the MIMO decoder 412.

The MIMO decoder 412 may be a minimum mean square error (MMSE) decoder, an MMSE-successive interference cancellation (SIC) decoder, a maximum likelihood (ML) decoder, or a decoder using any other advanced techniques for MIMO. MIMO decoding using a linear MMSE (LMMSE) decoder may be expressed as follows:
R=Rₛₛ\tilde{H}^{H}(\tilde{H}Rₛₛ\tilde{H}^{H}+Rᵥᵥ)⁻¹; Equation (3)
where R is a receive processing matrix, Rₛₛ and Rᵥᵥ are correlation matrices and H is an effective channel matrix which includes the effect of the V matrix on the estimated channel response.

The STD 414 decodes the STC if STC has been used at the WTRU 200. SFBC or STBC decoding with MMSE may be expressed as follows:
R=(\tilde{H}^{H}R\tilde{H}vv⁻¹\tilde{H}+Rₛₛ⁻¹)⁻¹\tilde{H}^{H}Rᵥᵥ⁻¹; Equation (4)
where R is the receive processing matrix, \tilde{H} is an estimated channel matrix, and Rₛₛ and Rᵥᵥ are the correlation matrices for the data and noise, respectively. When transmit beamforming is used, \tilde{H} is the effective channel matrix which includes the effect of the V matrix on the estimated channel response.

$$\tilde{H} = [ \begin{matrix}{h}_{11} & - {h}_{12} \\ {h}_{21} & - {h}_{22} \\ {h}_{12}^{*} & {h}_{11}^{*} \\ {h}_{22}^{*} & {h}_{21}^{*}\end{matrix} ] . \qquad Equation ( 5 )$$

The channel coefficients hᵢⱼ in the channel matrix \tilde{H} is the channel response corresponding to transmit antenna j and receiving antenna i.

STC, (i.e., STBC or SFBC), is advantageous over transmit beamforming at a low SNR. In particular, simulation results demonstrate the advantage of using STC at a low SNR over transmit beamforming. STC does not require channel state information feedback, and is simple to implement. STBC is robust against channels that have high frequency selectivity while SFBC is robust against channels that have high time selectivity. SFBC may be decodable in a single symbol and may be advantageous when low latency is required, (e.g., voice over IP (VoIP)). Under quasi-static conditions both SFBC and STBC provide similar performance.

In a distributed method of subcarrier assignment for SC-FDMA where the assigned subcarriers for a WTRU are uniformly distributed across the entire bandwidth, STBC may be more suitable than SFBC in the sense that two SFBC symbols for the assigned subcarriers may be far away in frequency. Thus, the frequency selectivity effect for SFBC is more prominent which may result in performance degradation. Both SFBC and STBC may be suitable for localized assignment of subcarriers where the assigned subcarriers are close to each other in frequency and less frequency selectivity is experienced.

Transmit beamforming approaches the Shannon bound at a high SNR for a low complexity MMSE detector at the base station. Because it uses transmit processing at the WTRU it minimizes the required transmit power at the expense of additional feedback. SM can also be supported by the transmit beamforming architecture transparently with no-feedback needed.

Referring again to FIG. 4, after MIMO decoding (if STC is not used) or after space time decoding (if STC is used), the decoded data 413a-413n or 415a-415n is processed by the IFFT units 416a-416n for conversion to time domain data 417a-417n. The time domain data 417a-417n is processed by the demodulators 418a-418n to generate soft bits 419a-419n. The scaling units 420a-420n compute a scaling factor for each of the soft bits based on the SNR on the received symbols and apply the scaling factor to the soft bits, which will be explained in detail hereinafter. The scaled soft bits 421a-421n are processed by the de-interleavers 422a-422n, which is an opposite operation of the interleavers 208a-208n of the WTRU 200 of FIG. 2. The de-interleaved bit streams 423a-423n are merged by the spatial de-parser 424. The merged bit stream 425 is then processed by the de-rate matching unit 426 and decoder 428 to recover the data 429.

Computation of the scaling factor and scaling of the soft bits are explained hereinafter. Let the covariance matrix of noise v be E{vv^{H}}=Iσ² where I is an identity matrix. For subcarrier n and spreading factor N for FFT spreading, the received signal after the receive processing can be expressed as follows:
\vec{z}ₙ=Rₙ\vec{y}ₙ, n=1, 2, . . . , N; Equation (6)
or
\vec{z}ₙ=\vec{s}ₙ+Rₙ\vec{v}ₙ, n=1, 2, . . . , N; Equation (7)
where \vec{z}ₙ is the received signal after receive processing and before IFFT despreading for subcarrier n. Each \vec{s}ₙ in Equations (6) or (7) contains M components corresponding to M data streams or antennas. \vec{s}ₙ=[sₙ⁽¹⁾ sₙ⁽²⁾ . . . sₙ^{(M)}]^{T} where sₙ^{(m)} is the component in frequency domain for subcarrier n and data stream or antenna m. Similarly, for each receive processing matrix Rₙ for subcarrier n, the receive processing matrix contains M rows corresponding to M data streams or antennas and can be expressed as follows:

$${R}_{n} = [ \begin{matrix}{R}_{n} ( 1 , : ) \\ {R}_{n} ( 2 , : ) \\ ⋮ \\ {R}_{n} ( M , : )\end{matrix} ] ; \qquad Equation ( 8 )$$

where Rₙ(m,:) represents the m-th row of the matrix corresponding to the m-th data stream or antenna for subcarrier n.

To obtain the estimates for transmitted symbol d(n) of the n-th data symbol, the IFFT is performed across N subcarriers. This is performed for each data stream or antenna. For data stream or antenna m, the signal model for IFFT despreading can be expressed as follows:

$$\begin{matrix}[ \begin{matrix}{\hat{d}}^{( m )} ( 1 ) \\ {\hat{d}}^{( m )} ( 2 ) \\ ⋮ \\ {\hat{d}}^{( m )} ( N )\end{matrix} ] = {F}^{- 1} [ \begin{matrix}{z}_{1}^{( m )} \\ {z}_{2}^{( m )} \\ ⋮ \\ {z}_{N}^{( m )}\end{matrix} ] ; \\ or & Equation ( 9 ) \\ [ \begin{matrix}{\hat{d}}^{( m )} ( 1 ) \\ {\hat{d}}^{( m )} ( 2 ) \\ ⋮ \\ {\hat{d}}^{( m )} ( N )\end{matrix} ] = [ \begin{matrix}{d}^{( m )} ( 1 ) \\ {d}^{( m )} ( 2 ) \\ ⋮ \\ {d}^{( m )} ( N )\end{matrix} ] + {F}^{- 1} [ \begin{matrix}{R}_{1} ( m , : ) \\ {R}_{2} ( m , : ) \\ ⋮ \\ {R}_{N} ( m , : )\end{matrix} ] \vec{v} ; & Equation ( 10 )\end{matrix}$$

where Rₙ(m,:) represents the m-th row of matrix Rₙ.

Equation (10) is rewritten as follows:

$$\begin{matrix}[ \begin{matrix}{\hat{d}}^{( m )} ( 1 ) \\ {\hat{d}}^{( m )} ( 2 ) \\ ⋮ \\ {\hat{d}}^{( m )} ( N )\end{matrix} ] = [ \begin{matrix}{d}^{( m )} ( 1 ) \\ {d}^{( m )} ( 2 ) \\ ⋮ \\ {d}^{( m )} ( N )\end{matrix} ] + B \vec{v} ; \\ where & Equation ( 11 ) \\ B = {F}^{- 1} [ \begin{matrix}{R}_{1} ( m , : ) \\ {R}_{2} ( m , : ) \\ ⋮ \\ {R}_{N} ( m , : )\end{matrix} ] = D [ \begin{matrix}{R}_{1} ( m , : ) \\ {R}_{2} ( m , : ) \\ ⋮ \\ {R}_{N} ( m , : )\end{matrix} ] . & Equation ( 12 )\end{matrix}$$

The noise power for n-th data symbol of antenna m, d (m) (n), is the n-th diagonal component of the covariance matrix of Bv. Denote Cov as such covariance matrix:
Cov^{(m)}=B^{(m)}\vec{v}\vec{v}^{H}B^{(m)}^{^{H}}; Equation (13)
or
Cov^{(m)}=σ²·B^{(m)}B^{(m)}^{^{H}}. Equation (14)
The noise power of the n-th data symbol from antenna m is Cov^{(m)} (n, n), (i.e., the n-th diagonal component of covariance matrix Cov^{(m)}).

For a proper MIMO detection, the signal strength at the receiver after receive processing and IFFT processing should be the same as the original signal strength before transmit processing and FFT spreading at the transmitter, (i.e., F⁻¹RHT\vec{s}≈\vec{d}). Therefore, the soft demapping output from the demodulators 418a-418n is scaled based on its SNR for each data symbol and each data stream or antenna. For calculation of the scaling factor for the n-th data symbol and the m-th data stream or antenna, a covariance matrix Cov^{(m)} is computed as follows:
Cov^{(m)}(n,n)=ρ²·B^{(m)}(n,:)B^{(m)}(n,:)^{H}; Equation (15)
where B^{(m)} is the processing matrix B, (i.e., the combined receive processing and IFFT matrix), for data stream or antenna m. A scaling factor

$$\frac{1}{\sqrt{{Cov}^{( m )} ( n , n )}}$$

is then multiplied to the soft bits \hat{b}ᵢ^{(m)}(n) that are output from the demodulators 418a-418n, where \hat{b}ᵢ^{(m)}(n) is the i-th soft bit for the n-th data symbol of the m-th data stream or antenna.

The scaling factor for the data symbols at a given data stream or antenna may be very close to each other within a coherent time where the channel is unchanged. This is because each data symbol is spread across N subcarriers at the antenna or data stream and the SNR of the symbol is implicitly averaged across different subcarriers. Thus, the calculation of the scaling factor may be reduced in complexity or the accuracy of the SNR may be improved. However, the scaling factor may vary from data stream to data stream or antenna to antenna due to different eigenvalues of the beamforming or the channel gain of the data streams.

Transmit beamforming at the WTRU 200 requires CSI for computing a preceding matrix V and computation of the V matrix requires eigen-decomposition. The Node-B 400 includes a channel state feedback unit (not shown) to send the channel state information to the WTRU. The feedback requirements for multiple antennas grow with the product of the number of transmit antennas and receive antennas as well as the delay spread, while capacity only grows linearly. Therefore, for transmit beamforming at the WTRU, a method to reduce the feedback requirements from the Node-B is desired. In order to reduce feedback requirements, a limited feedback may be used. The most straight forward method for limited feedback is channel vector quantization (VQ). A vectorized codebook may be constructed using an interpolation method. In a matrix-based precoding method, feedback or quantization may be used. In the matrix-based preceding method, the best precoding matrix in a codebook is selected and an index to the selected precoding matrix is fed back. The best precoding matrix is determined based on predetermined selection criteria such as the largest SNR, the highest correlation or any other appropriate metrics. In order to reduce computational requirements of the WTRU, a quantized precoding may be used.

Whether the eigen-decomposition required for obtaining the V matrix is performed either at the WTRU 200, Node-B 400, or both, information regarding the CSI is still needed at the WTRU 200. If the eigen-decomposition is performed at the Node-B 400, the CSI may be used at the WTRU 200 to further improve the estimate of the transmit precoding matrix at the WTRU 200.

A robust feedback of the spatial channel may be obtained by averaging across frequency. This method may be referred to as statistical feedback. Statistical feedback may be either mean feedback or covariance feedback. Since covariance information is averaging across the subcarriers, the feedback parameters for all subcarriers are the same, while mean feedback must be done for each individual subcarrier or group of subcarriers. Consequently, the latter requires more signaling overhead. Since the channel exhibits statistical reciprocity for covariance feedback, implicit feedback may be used for transmit beamforming from the WTRU 200. Covariance feedback is also less sensitive to feedback delay as compared to per-subcarrier mean feedback.

Although the features and elements of the present invention are described in the preferred embodiments in particular combinations and for particular frame, subframe or timeslot format, each feature or element can be used alone without the other features and elements of the preferred embodiments or in various combinations with or without other features and elements of the present invention and can be used for other frame, subframe and timeslot formats. The methods provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any integrated circuit, and/or a state machine.

A processor in association with software may be used to implement a radio frequency transceiver for use in a WTRU, user equipment, terminal, base station, radio network controller, or any host computer. The WWTRU may be used in conjunction with modules, implemented in hardware and/or software, such as a camera, a videocamera module, a videophone, a speakerphone, a vibration device, a speaker, a microphone, a television transceiver, a handsfree headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of scaling a soft bit for decoding in a wireless communication system, the method comprising:
calculating a scaling factor for a received symbol based on an estimated signal-to-noise ratio (SNR) of the received symbol; and
applying the scaling factor to a soft bit of the received symbol.

2. The method of claim 1 wherein a multiple-input multiple-output (MIMO) scheme is implemented to transmit and receive multiple data streams and a soft bit of a received symbol on each data stream is scaled by a scaling factor for the received symbol on each data stream.

3. The method of claim 1 wherein the wireless communication system is a single carrier frequency division multiple access (SC-FDMA) system.

4. A method of scaling a soft bit for decoding in a single carrier frequency division multiple access (SC-FDMA) system, the method comprising:
receiving symbols y;
performing a receive processing on the symbols y to obtain a signal z such that z=Ry, R being a receive processing matrix;
performing an inverse Fourier transform on the signal z to obtain an estimated symbol d such that d=Dz, D being an inverse Fourier transform matrix;
generating a covariance matrix Cov of Bv, Cov=σ²BB^{H}, B=DR, v being a noise vector; and
applying
$$\frac{1}{\sqrt{Cov ( n , n )}}$$
to a soft bit of the n-th received symbol, Cov(n,n) being a n-th diagonal element of the covariance matrix Cov.

5. The method of claim 4 wherein a multiple-input multiple-output (MIMO) scheme is implemented to transmit and receive multiple data streams, the covariance matrix Cov is generated for each data stream and a scaling factor
$$\frac{1}{\sqrt{Cov ( n , n )}}$$
is multiplied to a soft bit of the n-th received symbol on each data stream.

6. An apparatus for scaling a soft bit for decoding in a wireless communication system, the apparatus comprising:
a scaling factor generator for calculating a scaling factor for a received symbol based on an estimated signal-to-noise ratio (SNR) of the received symbol;
a demodulator for generating a soft bit from the received symbol; and
a scaling unit for applying the scaling factor to the soft bit of the received symbol.

7. The apparatus of claim 6 further comprising:
a plurality of antennas for a multiple-input multiple-output (MIMO) scheme to receive multiple data streams wherein a soft bit of a received symbol on each data stream is scaled by a scaling factor for the received symbol on each data stream.

8. The apparatus of claim 7 wherein the wireless communication system is a single carrier frequency division multiple access (SC-FDMA) system.

9. An apparatus for scaling a soft bit for decoding in a single carrier frequency division multiple access (SC-FDMA) system, the apparatus comprising:
a receiver for receiving symbols y;
a receive processing unit for performing a receive processing on the symbols y to generate a signal z such that z=Ry, R being a receive processing matrix;
an inverse Fourier transform unit for performing an inverse Fourier transform on the signal z to obtain an estimated symbol d such that d=Dz, D being an inverse Fourier transform matrix;
a covariance matrix generator for generating a covariance matrix Cov of Bv, Cov=σ²BB^{H}, B=DR, v being a noise vector;
a modulator for generating a soft bit from the received symbol y; and
a scaling unit for applying
$$\frac{1}{\sqrt{Cov ( n , n )}}$$
to a soft bit of the n-th received symbol, Cov(n,n) being a n-th diagonal element of the covariance matrix Cov.

10. The apparatus of claim 9 further comprising:
a plurality of antennas for multiple-input multiple-output (MIMO) communication to receive multiple data streams wherein the covariance matrix generator generates a covariance matrix Cov for each data stream and the scaling unit applies a scaling factor
$$\frac{1}{\sqrt{Cov ( n , n )}}$$
to a soft bit of the n-th received symbol on each data stream.

11. A method of scaling a soft bit for decoding in a wireless communication system including a transmitter and a receiver, the method comprising:
receiving data transmitted by the transmitter;
performing a Fourier transform on the received data to generate frequency domain data;
performing a subcarrier de-mapping to generate subcarrier de-mapped data;
generating channel estimate;
performing receive processing on the subcarrier de-mapped data based on the channel estimate;
performing an inverse Fourier transform after the receive processing to generate a symbol;
demodulating the symbol to generate soft bits;
calculating a scaling factor for the symbol based on an estimated signal-to-noise ratio (SNR) of the symbol; and
applying the scaling factor to the soft bits.

12. The method of claim 11 wherein a covariance matrix Cov of Bv, Cov=σ²BB^{H}, is generated, B=DR, D being an inverse Fourier transform matrix, R being a receive processing matrix, v being a noise vector and
$$\frac{1}{\sqrt{Cov ( n , n )}}$$
is multiplied as the scaling factor to a soft bit of the n-th received symbol, Cov(n,n) being a n-th diagonal element of the covariance matrix Cov.

13. The method of claim 11 wherein the wireless communication system is a single carrier frequency division multiple access (SC-FDMA) system.

14. The method of claim 11 wherein the wireless communication system is a multiple-input multiple output (MIMO) single carrier frequency division multiple access (SC-FDMA) system.

15. A receiver for scaling a soft bit for decoding in a wireless communication system, the receiver comprising:
a Fourier transform unit for performing a Fourier transform on received data from a transmitter to generate frequency domain data;
a subcarrier de-mapping unit for performing a subcarrier de-mapping on the frequency domain data to generate subcarrier de-mapped data;
a channel estimator for generating channel estimate;
a receive processing unit for performing receive processing on the subcarrier de-mapped data based on the channel estimate;
an inverse Fourier transform unit for performing an inverse Fourier transform on an output of the receive processing unit to generate a symbol;
a de-modulator for demodulating the symbol to soft bits;
a scaling unit for calculating a scaling factor for the symbol based on an estimated signal-to-noise ratio (SNR) of the symbol and applying the scaling factor to the soft bits; and
a decoder for decoding the scaled soft bits.

16. The receiver of claim 15 wherein the scaling unit generates a covariance matrix Cov of Bv, Cov=σ²BB^{H}, B=DR, D being an inverse Fourier transform matrix, R being a receive processing matrix, v being a noise vector and applies
$$\frac{1}{\sqrt{Cov ( n , n )}}$$
as the scaling factor to a soft bit of the n-th received symbol, Cov(n,n) being a n-th diagonal element of the covariance matrix Cov.

17. The receiver of claim 15 wherein the wireless communication system is a single carrier frequency division multiple access (SC-FDMA) system.

18. The receiver of claim 15 wherein the wireless communication system is a multiple-input multiple output (MIMO) single carrier frequency division multiple access (SC-FDMA) system.
